(19) United States
(12) Patent Application Publication
(10) Pub. No.: US 2022/0009505 A1
(43) Pub. Date: Jan. 13, 2022

(54) DANGER PREDICTION DEVICE, DANGER PREDICTION SYSTEM, METHOD OF DANGER PREDICTION, AND STORAGE MEDIUM STORING PROGRAM

(71) Applicant: TOYOTA JIDOSHA KABUSHIKI KAISHA, Toyota-shi (JP)

(72) Inventors: Shintaro FUKUSHIMA, Chiyoda-ku (JP); Zenya NAGATA, Ota-ku (JP); Akie SAKIYAMA, Shinjuku-ku (JP); Kaoru YAMADA, Nagoya-shi (JP); Sayaka YOSHIZU, Yokohama-shi (JP); Takeyuki SASAI, Chiyoda-ku (JP)

(73) Assignee: TOYOTA JIDOSHA KABUSHIKI KAISHA, Toyota-shi (JP)

(21) Appl. No.: 17/343,958

(22) Filed: Jun. 10, 2021

(30) Foreign Application Priority Data
Jul. 7, 2020 (JP) 2020-117351

(51) Int. Cl. B60W 40/09; B60W 30/095

(52) U.S. Cl. CPC B60W 40/09; B60W 2555/20; B60W 30/095

(57) ABSTRACT

A danger prediction device includes a processor. The processor is configured to acquire, from a traveling vehicle, position information for the traveling vehicle on a travel path and behavior information for the traveling vehicle at a location corresponding to the position information, compile, from a plurality of acquired items of behavior information, behavior information corresponding to position information for locations having a similar attribute, and input compiled behavior information to a prediction model generated based on pre-gathered vehicle behavior information and a danger level corresponding to the pre-gathered vehicle behavior information, and perform danger prediction for a location corresponding to the compiled behavior information.

### CROSS-REFERENCE TO RELATED APPLICATION

This application is based on and claims priority under 35 USC 119 from Japanese Patent Application No 2020-117351 filed on Jul. 7, 2020, the disclosure of which is incorporated by reference herein.

### BACKGROUND

### Technical Field

The present disclosure relates to a danger prediction device, a danger prediction system, a method of danger prediction, and a storage medium storing a program for predicting danger on a travel path.

### Related Art

Japanese Patent Application Laid-Open (JP-A) No. 2012-38006 discloses a driving support device capable setting and drawing attention a degree of risk with improved precision. This driving support device sets a risk level for a road included in map data based on danger avoidance action occurrence information and accident occurrence information.

When such danger avoidance action occurrence information or accident occurrence information arises, the driving support device also takes into consideration such factors as weather conditions, the day of the week, the time of day, road surface conditions, and traffic volume.

When the technology of JP-A No. 2012-38006 is employed to reflect actual danger avoidance action or accident occurrence events when predicting danger on travel paths, for locations for which it has not been possible to secure sufficient data there is a possibility that isolated events occurring despite a low traffic volume could be detrimental to prediction quality.

### SUMMARY

An object of the present disclosure is to provide a danger prediction device, a danger prediction system, a method of danger prediction, and a storage medium storing a program that compile data for locations having a similar attribute, thereby enabling prediction precision to be improved even when predicting danger for locations for which it has not been possible to secure sufficient data.

A first aspect is a danger prediction device including an acquisition section configured to acquire, from a traveling vehicle, position information for the traveling vehicle on a travel path and behavior information for the traveling vehicle at a location corresponding to the position information, a compiling section configured to compile, from plural items of behavior information acquired by the acquisition section, behavior information corresponding to position information for locations having a similar attribute, and a prediction section configured to input behavior information compiled by the compiling section to a prediction model generated based on pre-gathered vehicle behavior information and a danger level corresponding to the pre-gathered vehicle behavior information, and perform danger prediction for a location corresponding to the compiled behavior information.

In the danger prediction device of the first aspect, when the acquisition section has acquired the position information and behavior information from the traveling vehicle, the compiling section compiles the behavior information into respective groups of locations having a similar attribute. The behavior information is data representing behavior of the traveling vehicle, and includes data regarding physical quantities such as the detected speed, acceleration, and steering angle of the traveling vehicle, as well as information representing states such as sudden acceleration, sudden braking, sudden steering wheel operation and the like, as determined based on these physical quantities. Examples of the attribute include the traffic volume, road width, incline, and the like of the travel path. The prediction section of the danger prediction device then inputs the compiled behavior information to the pre-generated prediction model to perform danger prediction for the location corresponding to the compiled behavior information. By compiling data for locations having a similar attribute, the danger prediction device is thus capable of improving prediction precision, even in cases in which danger prediction is performed for a location for which it has not been possible to secure sufficient data.

A danger prediction device of a second aspect is the danger prediction device of the first aspect, wherein, in a case in which locations having a similar attribute are set as nodes and the travel path is set as an edge, the compiling section is further configured to compile behavior information corresponding to position information for the nodes that are linked by the edge.

The danger prediction device of the second aspect performs compilation by utilizing a graph configured by the nodes and the edge. The danger prediction device is thus capable of compiling behavior information for locations with a strong relationship to each other in addition to having a similar attribute.

A danger prediction device of a third aspect is the danger prediction device of either the first aspect or the second aspect, wherein the acquisition section is further configured to acquire environmental information relating to an environment of the travel path, and the prediction section is further configured to reflect the acquired environmental information in prediction.

The danger prediction device of the third aspect performs danger prediction employing the environmental information in addition to the behavior information for the traveling vehicle. Note that the environmental information includes road information such as congestion information and roadworks information, meteorological information, and the like. The danger prediction device enables the environment of the travel path to be reflected in danger prediction.

A danger prediction device of a fourth aspect is the danger prediction device of any one of the first aspect to the third aspect, further including a training section configured to perform additional training of the prediction model based on the behavior information acquired by the acquisition section.

In the danger prediction device of the fourth aspect, the training section performs additional training of the prediction model. The danger prediction device employs the acquired behavior information to perform additional training of the prediction model, thus enabling previously acquired behavior information to be reflected in danger prediction based on subsequently acquired behavior information.

A danger prediction device of a fifth aspect is the danger prediction device of any one of the first aspect to the fourth aspect, wherein the prediction model is one of a plurality of prediction models, which respectively corresponding to a plurality of each similar attributes, and the prediction section is configured to employ plurality of the prediction models to perform danger prediction for locations corresponding to each of the plurality of similar attributes.

The danger prediction device of the fifth aspect employs a separate prediction model for each similar attribute, thereby enabling danger prediction to be performed according to the characteristics of similar locations.

A danger prediction device of a sixth aspect is the danger prediction device of the fifth aspect when including the fourth aspect, wherein the training section is further configured to perform additional training for each of the plurality of prediction models for corresponding locations based on behavior information for each of the plurality of similar attributes.

The danger prediction device of the sixth aspect reflects previously acquired behavior information when training the prediction model for each similar attribute, thereby enabling the precision of danger prediction for similar locations to be improved.

A danger prediction device of a seventh aspect is the danger prediction device of any one of the first aspect to the sixth aspect, further including a provision section configured to provide a vehicle with position information regarding a location that the prediction section has predicted to be dangerous.

The danger prediction device of the seventh aspect provides position information relating to a location that has been predicted to be dangerous directly to the vehicle. Vehicles providing the position information are not limited to the traveling vehicle from which the behavior information is acquired. The danger prediction device enables the vehicle to be provided with prediction results that are highly responsive to events such as accidents.

A danger prediction device of an eighth aspect is the danger prediction device of the seventh aspect, wherein the provision section is further configured to provide a vehicle with warning information when the vehicle approaches a location that the prediction section has predicted to be dangerous.

The danger prediction device of the eighth aspect is capable of alerting an occupant of the vehicle that is approaching a location that has been predicted to be dangerous.

A danger prediction system of a ninth aspect includes the danger prediction device of any one of the first aspect to the eighth aspect, and plural of the traveling vehicles. Each of the traveling vehicles is communicatively connected to the danger prediction device.

The danger prediction system of the ninth aspect acquires behavior information from the plural traveling vehicles. By increasing the number of vehicles connected the danger prediction device, the danger prediction system is capable of further improving the precision of danger prediction.

By compiling data for locations having similar attributes, the present disclosure is capable of improving prediction precision, even when performing danger prediction for locations for which it has not been possible to secure sufficient data.

### BRIEF DESCRIPTION OF THE DRAWINGS

Exemplary embodiments of the present disclosure will be described in detail based on the following figures, wherein:

FIG. 1 is a diagram illustrating a schematic configuration of a danger prediction system according to a first exemplary embodiment;

FIG. 2 is a block diagram illustrating a hardware configuration of a vehicle of the first exemplary embodiment;

FIG. 3 is a block diagram illustrating a functional configuration of an onboard device of the first exemplary embodiment;

FIG. 4 is a block diagram illustrating a hardware configuration of a central server of the first exemplary embodiment;

FIG. 5 is a block diagram illustrating a functional configuration of a central server of the first exemplary embodiment;

FIG. 6 is a diagram illustrating an example of behavior information compilation by a central server of the first exemplary embodiment;

FIG. 7 is a sequence chart illustrating a flow of processing by a danger prediction system of the first exemplary embodiment;

FIG. 8A is a block diagram illustrating a flow of danger prediction processing employing compiled behavior information in the first exemplary embodiment, illustrating a case in which danger prediction processing is being performed for the first time;

FIG. 8B is a block diagram illustrating a flow of danger prediction processing employing compiled behavior information in the first exemplary embodiment, illustrating a case in which danger prediction processing is being performed based on updated compiled data sets;

FIG. 9 is a diagram illustrating an example of reporting on a monitor in the first exemplary embodiment;

FIG. 10 is a diagram illustrating another example of reporting on a monitor in the first exemplary embodiment;

FIG. 11A is a block diagram illustrating a flow of danger prediction processing employing compiled behavior information in a second exemplary embodiment, illustrating a case in which danger prediction processing is being performed for the first time;

FIG. 11B is a block diagram illustrating a flow of danger prediction processing employing compiled behavior information in the second exemplary embodiment, illustrating a case in which danger prediction processing is being performed based on updated compiled data sets;

FIG. 12A is a block diagram illustrating a flow of danger prediction processing and additional training employing compiled behavior information in a third exemplary embodiment, illustrating a case in which danger prediction processing is being performed for the first time;

FIG. 12B is a block diagram illustrating a flow of danger prediction processing and additional training employing compiled behavior information in the third exemplary embodiment, illustrating a case in which danger prediction processing is being performed based on updated compiled data sets;

FIG. 13A is a block diagram illustrating a flow of danger prediction processing and additional training employing compiled behavior information in a fourth exemplary embodiment, illustrating a case in which danger prediction processing is being performed for the first time; and

FIG. 13B is block diagram illustrating a flow of danger prediction processing and additional training employing compiled behavior information in the fourth exemplary embodiment, illustrating a case in which danger prediction processing is being performed based on updated compiled data sets.

### DETAILED DESCRIPTION

### First Exemplary Embodiment

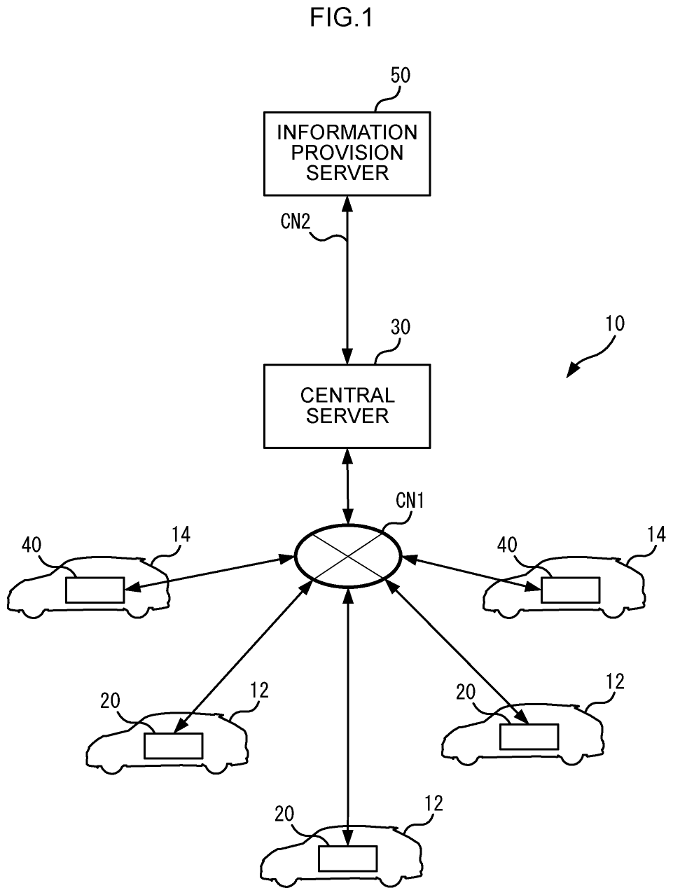

As illustrated in FIG. 1, a danger prediction system 10 of a first exemplary embodiment is configured including plural vehicles 12, plural vehicles 14, a central server 30, and an information provision server 50. The vehicles 12 are each installed with an onboard device 20, and the vehicles 14 are each installed with a reporting device 40. The vehicles 12 are an example of traveling vehicles, and the central server 30 is an example of a danger prediction device.

The onboard devices 20 of the vehicles 12, the reporting devices 40 of the vehicles 14, and the central server 30 are connected to each other over a network CN1. The central server 30 and the information provision server 50 are connected to each other over a network CN2. Note that the central server 30 and the information provision server 50 may be connected to each other over the network CN1.

### Vehicles

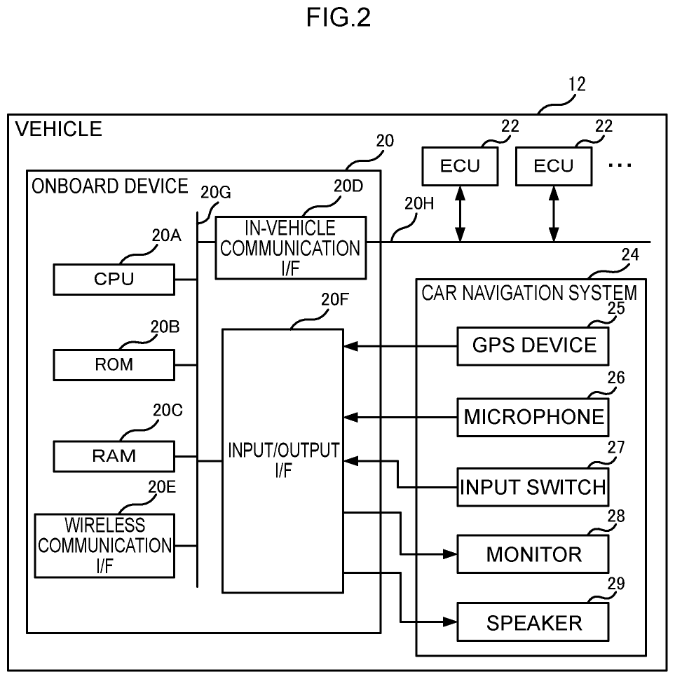

As illustrated in FIG. 2, the vehicles 12 according to the present exemplary embodiment are each configured including the onboard device 20, plural ECUs 22, and a car navigation system 24. The car navigation system 24 is further configured including a global positioning system (GPS) device 25, a microphone 26, serving as a sound input device, an input switch 27, serving as an operation input device, a monitor 28, serving as a display device, and a speaker 29.

The onboard device 20 is configured including a central processing unit (CPU) 20A, read only memory (ROM) 20B, random access memory (RAM) 20C, an in-vehicle communication interface (I/F) 20D, a wireless communication I/F 20E, and an input/output I/F 20F. The CPU 20A, the ROM 20B, the RAM 20C, the in-vehicle communication I/F 20D, the wireless communication I/F 20E, and the input/output I/F 20F are connected together through an internal bus 20G so as to be capable of communicating with each other.

The CPU 20A is a central processing unit that executes various programs and controls various sections. Namely, the CPU 20A reads a program from the ROM 20B and executes the program using the RAM 20C as a workspace.

The ROM 20B stores various programs and various data. The ROM 20B of the present exemplary embodiment is stored with a control program used to control the onboard device 20.

The RAM 20C serves as a workspace that temporarily stores programs and data.

The in-vehicle communication I/F 20D is an interface used to connect with the ECUs 22. This interface may employ a CAN communication protocol. The in-vehicle communication I/F 20D is connected to an external bus 20H. Each of the vehicles 12 is provided with plural of the ECUs 22, corresponding to respective functions. Examples of the ECUs 22 of the present exemplary embodiment include a vehicle control ECU, an engine ECU, a brake ECU, a body ECU, a camera ECU, and a multimedia ECU.

The wireless communication I/F 20E is a wireless communication module for communicating with the central server 30. A communication standard such as 5G, LTE, or Wi-Fi (registered trademark) is employed for this wireless communication module. The wireless communication I/F 20E is connected to the network CN1.

The input/output I/F 20F is an interface for communicating with the GPS device 25, the microphone 26, the input switch 27, the monitor 28, and the speaker 29 of the car navigation system 24.

The GPS device 25 is a device that measures a current position of the vehicle 12. The GPS device 25 includes an antenna that receives signals from a GPS satellite.

The microphone 26 is a device that is for example provided to a front pillar or a dashboard of the vehicle 12 in order to pick up sounds uttered by a user, namely an occupant of the vehicle 12.

The input switch 27 is configured by a touch panel that doubles as the monitor 28. Note that the input switch 27 may also be a switch provided to an instrument panel, a center console, or a steering wheel and input with operation by the fingers of an occupant. A push-button ten-key pad, a touch pad, or the like may be adopted as the input switch 27 in such cases.

The monitor 28 is a liquid crystal monitor that is provided to an instrument panel, a meter panel, or the like in order to display images relating to the current location, travel route, and warning information. As described above, the monitor 28 is provided in the form of a touch panel that doubles as the input switch 27.

The speaker 29 is provided in the instrument panel, center console, front pillar, dashboard, or the like, and is a device used to output audio relating to warning information and the like.

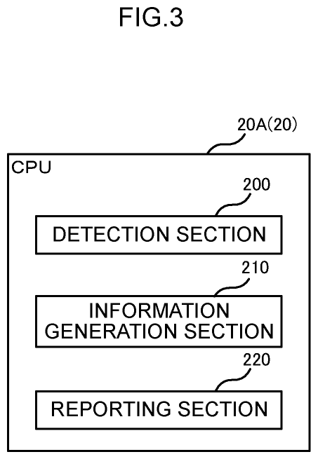

The CPU 20A of the onboard device 20 of the present exemplary embodiment executes the control program in order to function as a detection section 200, an information generation section 210, and a reporting section 220, illustrated in FIG. 3.

The detection section 200 has a function of using the respective ECUs 22 to detect speed, acceleration, a steering angle, and the like of the vehicle 12.

The information generation section 210 has a function of generating behavior information, this being data representing behavior of the vehicle 12. In this example, the behavior information is data representing behavior of the vehicles 12, and includes data regarding physical quantities such as the detected speed, acceleration, and steering angle of the respective vehicles 12, as well as information representing states such as sudden acceleration, sudden braking, sudden steering wheel operation and the like, as determined based on these physical quantities. The information generation section 210 generates behavior information based on the physical quantities detected by the detection section 200 and the states determined based on these physical quantities.

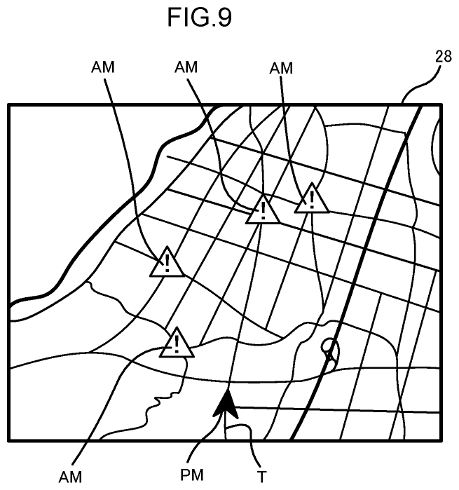

The reporting section 220 has a function of reporting warning information to an occupant of the vehicle 12. In this example, the warning information includes position information for a location where danger has been predicted by the central server 30 (such locations are referred to hereafter as “dangerous locations”), and the nature of such danger (for example, a stop signal where rear-end shunt accidents occur frequently). In cases in which the reporting section 220 has acquired warning information including a dangerous location from the central server 30, this warning information is reported using the car navigation system 24. For example, the reporting section 220 may display an alert mark AM corresponding to the dangerous location on the monitor 28 (see FIG. 9), or may output audio to notify of the approaching dangerous location through the speaker 29. Specific implementations of this reporting will be described later.

As illustrated in FIG. 1, each of the vehicles 14 according to the present exemplary embodiment is configured including the reporting device 40. The reporting device 40 is connected to the network CN1, and is capable of communicating with the central server 30. Although the reporting device 40 does not have a function to generate behavior information or to provide such behavior information to the central server 30, the reporting device 40 has at least a function corresponding to that of the reporting section 220 of the onboard device 20. Namely, in cases in which the reporting device 40 in the vehicle 14 has acquired warning information from the central server 30, this warning information is reported using a car navigation system or the like.

### Central Server

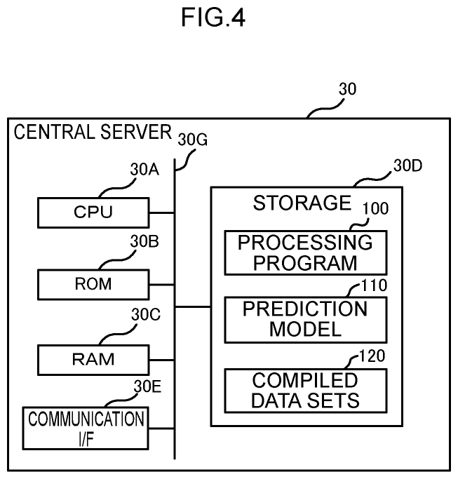

As illustrated in FIG. 4, the central server 30 is configured including a CPU 30A, ROM 30B, RAM 30C, storage 30D, and a communication I/F 30E. The CPU 30A, the ROM 30B, the RAM 30C, the storage 30D, and the communication I/F 30E are connected together through an internal bus 30G so as to be capable of communicating with each other. Functionality of the CPU 30A, the ROM 30B, the RAM 30C, and the communication I/F 30E is similar to that of the CPU 20A, the ROM 20B, the RAM 20C, and the wireless communication I/F 20E of the onboard device 20 described above.

The storage 30D is configured by a hard disk drive (HDD) or solid state drive (SSD), and stores various programs and various data.

The CPU 30A reads a program from the storage 30D and executes the program using the RAM 30C as a workspace.

The storage 30D of the present exemplary embodiment is stored with a processing program 100, a prediction model 110, and compiled data sets 120. The processing program 100 is a program for implementing the respective functions of the central server 30.

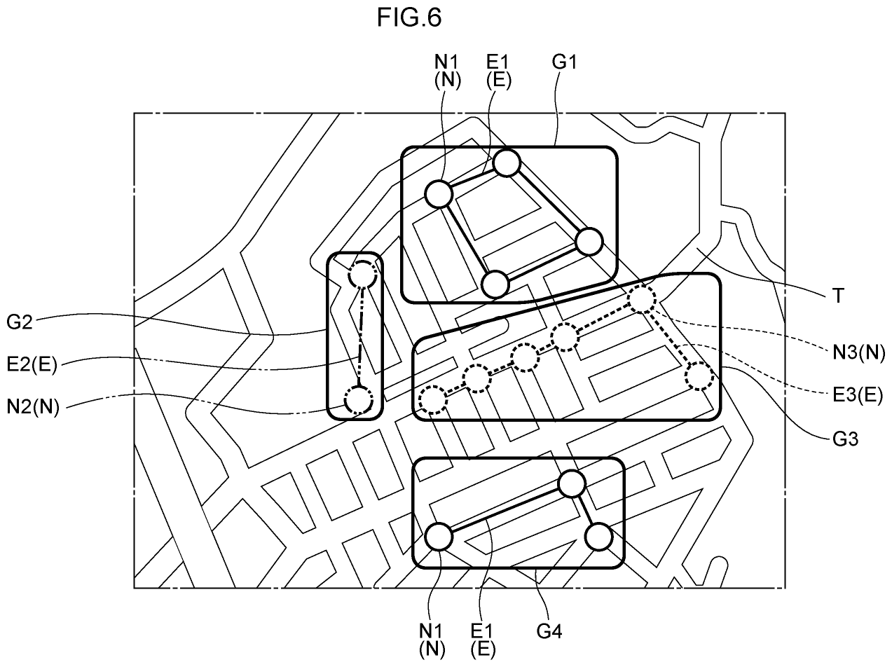

The prediction model 110 is a trained model generated in order to predict danger on travel paths T (see FIG. 6).

The compiled data sets 120 are stored with behavior information relating to the vehicles 12. This behavior information is compiled for each similar attribute and stored in this state.

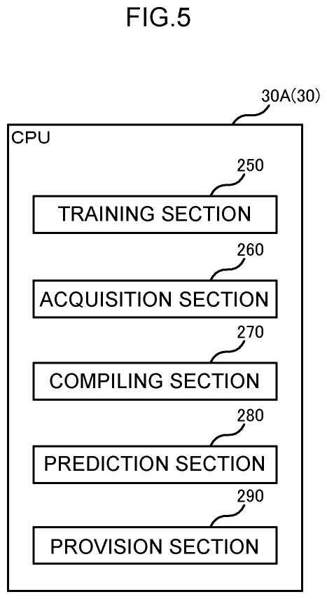

The CPU 30A of the central server 30 of the present exemplary embodiment executes the processing program 100 in order to function as a training section 250, an acquisition section 260, a compiling section 270, a prediction section 280, and a provision section 290, illustrated in FIG. 5.

The training section 250 has a function of performing machine learning to generate the prediction model 110 based on pre-gathered behavior information and danger levels corresponding to this behavior information. The danger levels refer to, for example, incidence counts and incidence rates of sudden acceleration, sudden braking and sudden steering wheel operation, as well as statistically obtained accident rates. The training section 250 also has a function of updating the prediction model 110 by performing additional training based on new behavior information acquired from the onboard devices 20 of the vehicles 12.

The acquisition section 260 has a function of acquiring various information from the vehicles 12 and from the central server 30. Specifically, from the respective vehicles 12, the acquisition section 260 acquires position information of the vehicles 12 on the travel paths T and behavior information of the respective vehicles 12 at locations corresponding to this position information. The acquisition section 260 is also capable of acquiring environmental information relating to the environment of the travel paths T from the information provision server 50. In this example, the environmental information of the travel path T includes road information (for example congestion information and roadworks information), meteorological information, and the like. Changes in traffic volume due to changes in surrounding roads and structures may also be applied as environmental information.

The compiling section 270 has a function of compiling the plural pieces of behavior information acquired by the acquisition section 260 based on predetermined rules. Specifically, the compiling section 270 categorizes locations by similar attributes, and compiles the behavior information according to the position information corresponding to these categorized locations. Note that in this example, the attributes may be related to traffic volume, road width, incline, and the like of the travel paths T. As illustrated in FIG. 6, the compiling section 270 of the present exemplary embodiment sets locations having a similar attribute as nodes N and sets the travel paths T as edges E, and compiles the behavior information according to a graph configured by the nodes N and the edges E. Note that the storage 30D of the present exemplary embodiment is stored with map data expressing connections between locations, with locations configuring the nodes N and the travel paths T configuring the edges E, and the graph is generated with reference to this map data.

FIG. 6 illustrates an example of a case in which the attribute is the traffic volume on the travel paths T. The compiling section 270 sets locations with an average hourly traffic volume in a range of from 0 to 9 as nodes N1, and compiles behavior information in a group G1 and in a group G4, each including links configured by edges E1. In the example of the present exemplary embodiment, the nodes N1 having a similar attribute are split between two groups, namely the group G1 and the group G4, and the behavior information is compiled separately for each of these groups.

Moreover, the compiling section 270 sets locations with an average hourly traffic volume in a range of from 10 to 19 as nodes N2, and compiles behavior information in a group G2 that is linked by edges E2. The compiling section 270 sets locations with an average hourly traffic volume in a range of from 20 to 29 as nodes N3, and compiles behavior information in a group G3 that is linked by edges E3.

The prediction section 280 has a function of inputting the compiled behavior information to the prediction model 110 in order to predict danger at locations in the compiled behavior information. The prediction section 280 is also capable of reflecting the acquired environmental information in its predictions. For example, in a case in which the acquisition section 260 has acquired information that torrential rain is falling as meteorological information from the information provision server 50, the prediction section 280 may predict a corresponding location to be dangerous even if this location would not predicted to be dangerous in good weather.

The provision section 290 has a function of providing warning information to the vehicles 12, 14. Specifically, the provision section 290 generates warning information by appending danger details to the position information corresponding to a dangerous location that the prediction section 280 has predicted to be dangerous, and transmits this warning information to the vehicles 12, 14. Moreover, in a case in which a vehicle 12 or 14 is approaching a location that the prediction section 280 has predicted to be dangerous, the provision section 290 is capable of providing the warning information to the vehicle 12 or 14 that is approaching the dangerous location.

### Information Provision Server

The information provision server 50 has a function of providing environmental information relating to the environment of the travel paths T to the central server 30. The information provision server 50 gathers congestion information and roadworks information as road information from a server of a traffic information provider, and gathers meteorological information from a server of a meteorological information provider.

### Control Flow

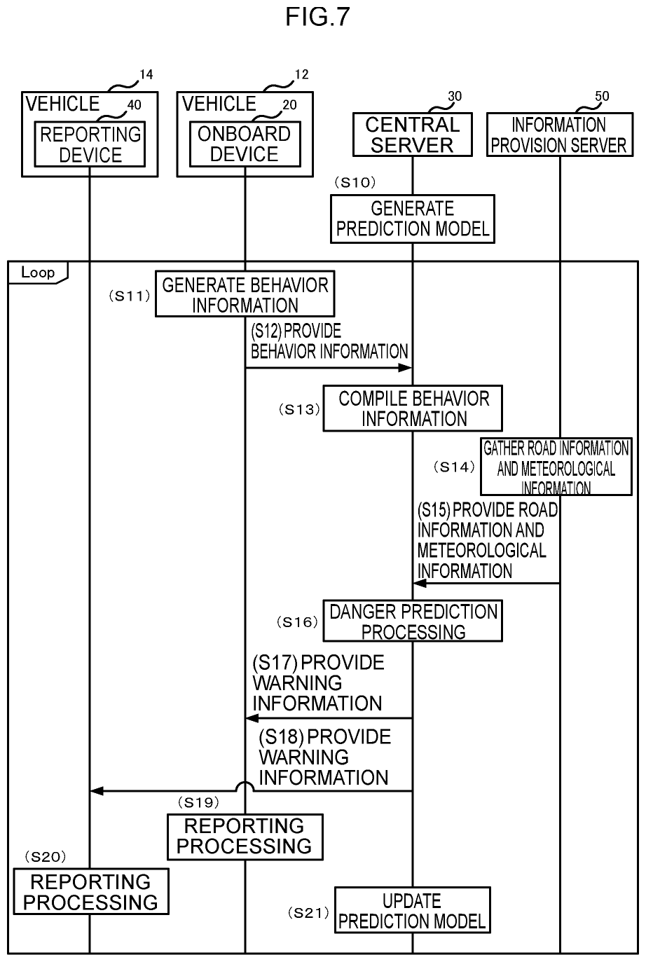

Explanation follows regarding a flow of processing executed by the danger prediction system 10 of the present exemplary embodiment, with reference to the sequence chart of FIG. 7.

At step S10 in FIG. 7, the central server 30 generates the prediction model 110 based on the pre-gathered behavior information and the danger levels corresponding to this behavior information. The behavior information is gathered not only from the vehicles 12 but also from the vehicles 14 and other vehicles.

At step S11, each of the onboard devices 20 generates the behavior information for the corresponding vehicle 12.

At step S12, the onboard devices 20 provide the behavior information to the central server 30.

At step S13, the central server 30 compiles the behavior information acquired from the plural onboard devices 20. As described above, the central server 30 of the present exemplary embodiment uses the traffic volumes of the travel paths T as an attribute, and therefore compiles the behavior information into groups, with each group having similar average traffic volumes.

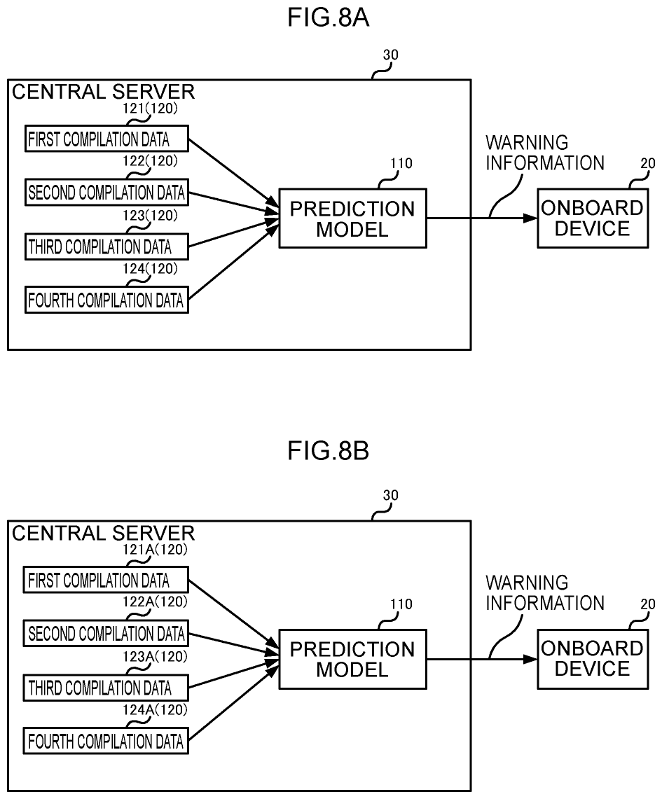

In the example of the present exemplary embodiment (see FIG. 6), as a result of performing this compilation, compilation data in the compiled data sets 120 is held by group, as illustrated in FIG. 8A. Specifically, the compiled data sets 120 include first compilation data 121 in which behavior information for the group G1 has been compiled, second compilation data 122 in which behavior information for the group G2 has been compiled, third compilation data 123 in which behavior information for the group G3 has been compiled, and fourth compilation data 124 in which behavior information for the group G4 has been compiled.

At step S14 in FIG. 7, the information provision server 50 gathers road information and meteorological information.

At step S15, the information provision server 50 provides the road information and meteorological information to the central server 30. Note that the road information and meteorological information are not essential information for danger prediction in danger prediction processing, described later. Step S14 and step S15 may therefore be omitted.

At step S16, the central server 30 executes the danger prediction processing. In this danger prediction processing, the behavior information compiled at step S13 is input to the prediction model 110, and danger prediction is performed for the respective locations corresponding to the compiled behavior information. In the present exemplary embodiment, as illustrated in FIG. 8A the first compilation data 121, the second compilation data 122, the third compilation data 123, and the fourth compilation data 124 are all input to the prediction model 110. Warning information is then generated based on the predicted dangerous locations.

At step S17 in FIG. 7, the central server 30 provides the warning information to the onboard devices 20 of the vehicles 12 (see FIG. 8A).

At step S18, the central server 30 provides the warning information to the reporting devices 40 of the vehicles 14.

At step S19, the respective onboard devices 20 execute reporting processing. For example, as illustrated in FIG. 9, the onboard devices 20 display a current location mark PM indicating the current position of the corresponding vehicle 12 and alert marks AM indicating dangerous locations on a map displayed on the monitor 28 of the car navigation system 24.

At step S20, the reporting device 40 executes reporting processing. Implementation of reporting by the reporting device 40 is similar to the implementation of reporting by the onboard devices 20 (see step S19).

At step S21, the central server 30 updates the prediction model 110. Specifically, the central server 30 performs additional training based on the behavior information compiled at step S13. Processing then returns to step S11.

The processing from step S11 to step S21 is repeated in a loop.

Note that when the central server 30 re-compiles behavior information as part of this looped processing (step S13), as illustrated in FIG. 8B, the compiled data sets 120 are updated to configure first compilation data 121A, second compilation data 122A, third compilation data 123A, and fourth compilation data 124A. In the danger prediction processing of step S16, the first compilation data 121A, second compilation data 122A, third compilation data 123A, and fourth compilation data 124A are input to the prediction model 110 so as to output new prediction results.

### Other Implementations of Reporting

The following implementations of the reporting processing of the onboard devices 20 of the present exemplary embodiment may also be adopted.

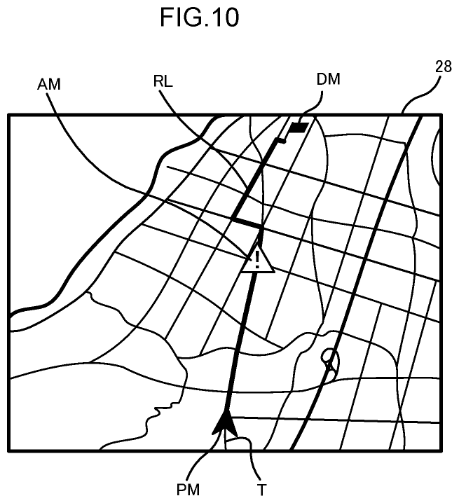

For example, as illustrated in FIG. 10, when a travel route to a destination has been set on the car navigation system 24, the corresponding onboard device 20 may report a dangerous location on the travel route using the monitor 28 and the speaker 29. For example, in a case in which a dangerous location is present on the travel route linking the current location to the destination, in addition to a route line RL indicating the travel route and a destination mark DM indicating the destination, an alert mark AM is also displayed over the route line RL. In such cases, the onboard device 20 outputs audio such as “The crossroad at XX is known for dangerous driving”, or “XX (name of a facility) is an accident blackspot” from the speaker 29.

Alternatively, if the vehicle 12 is approaching a dangerous location, the onboard device 20 may report the dangerous location by for example outputting audio advising of the approach of the dangerous location through the speaker 29, and displaying a banner advising of the approach of the dangerous location on the monitor 28. The dangerous location may further be reported by utilizing an agent function of the car navigation system 24. For example, in a case in which an occupant of the vehicle 12 has addressed the microphone 26 with the utterance “Tell me where dangerous locations are”, information regarding dangerous locations may be output as audio from the speaker 29 by way of response to the intent of this utterance. Specifically, audio such as “There is a location known for dangerous driving ahead”, “There is an accident blackspot ahead”, “The crossroad XX meters ahead is known for dangerous driving”, or “The next expressway exit is an accident blackspot” is output from the speaker 29.

Note that the following method for reporting a dangerous location may be applied in addition to the method described above, in which the onboard device 20, having acquired warning information in advance, determines the approach of the dangerous location and reports the approach of the dangerous location when the vehicle 12 approaches the dangerous location. For example, the central server 30 may determine that a vehicle 12 is approaching a dangerous location based on the position information of the vehicle 12, and when this approach has been determined, the central server 30 may provide warning information to the corresponding onboard device 20 such that the onboard device 20 reports the dangerous location. Such a configuration similarly enables the occupant of the vehicle 12 approaching the dangerous location to be alerted.

### First Exemplary Embodiment: Summary

In the danger prediction system 10 of the present exemplary embodiment, when the acquisition section 260 has acquired the position information and behavior information from the vehicles 12, the compiling section 270 compiles the behavior information in respective groups of locations having a similar attribute. The prediction section 280 then inputs compiled behavior information to the pre-generated prediction model 110 to perform danger prediction for the locations corresponding to the compiled behavior information. By compiling data for locations having a similar attribute, the present exemplary embodiment is thus capable of improving prediction precision, even in cases in which danger prediction is performed for locations for which it has not been possible to secure sufficient data.

In particular, the danger prediction system 10 of the present exemplary embodiment performs compilation by utilizing a graph configured by the nodes N and the edges E. The present exemplary embodiment is thus capable of compiling behavior information for locations with a strong relationship to each other in addition to having a similar attribute.

Moreover, the danger prediction system 10 of the present exemplary embodiment is capable of acquiring not only the behavior information of the vehicles 12 but also the environmental information from the information provision server 50 when performing danger prediction. For example, in a case in which information regarding a section of a travel path T that is closed to traffic due to roadworks is acquired from the information provision server 50 as the environmental information, the prediction section 280 excludes from its prediction a location on the travel path T where the vehicle 12 is prohibited from traveling. As a result, the provision section 290 is able to exclude from the warning information dangerous locations corresponding to locations where the travel path T is closed to traffic. As another example, in a case in which meteorological information regarding the occurrence of torrential rain has been acquired from the information provision server 50 as the environmental information, more specifically in cases in which meteorological information that a weather event exceeding a preset level is occurring at a location on a travel path T has been acquired, the prediction section 280 adds the location where the weather event exceeding the preset level is occurring to its prediction. As a result, the provision section 290 is able to add warning information regarding a dangerous location where there is a possibility of flooding on the travel path T. In this manner, the present exemplary embodiment enables the environment of the travel paths T to be reflected in danger prediction.

The danger prediction system 10 of the present exemplary embodiment provides position information relating to predicted dangerous locations directly to the vehicles 12 and the vehicles 14. The present exemplary embodiment thereby enables the vehicles 12 and the vehicles 14 to be provided with prediction results that are highly responsive to events such as accidents.

### Second Exemplary Embodiment

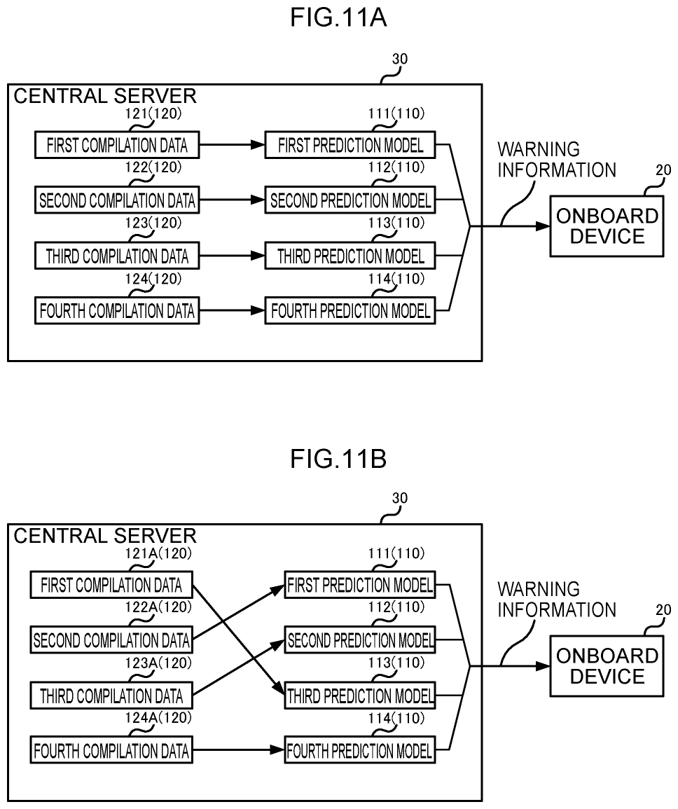

In the first exemplary embodiment, danger prediction is performed using the single prediction model 110. By contrast, as illustrated in FIG. 11A, a second exemplary embodiment differs from the first exemplary embodiment in that a prediction model 110 is provided for each attribute. In the following explanation, configurations matching those of the first exemplary embodiment are allocated the same reference numerals, and explanation thereof is omitted. Explanation follows regarding points that differ from the first exemplary embodiment.

The prediction models 110 of the present exemplary embodiment include a prediction model 110 for each attribute. Specifically, the prediction models 110 include a first prediction model 111 for the group G1, a second prediction model 112 for the group G2, a third prediction model 113 for the group G3, and a fourth prediction model 114 for the group G4.

The prediction section 280 of the present exemplary embodiment performs danger prediction by inputting behavior information to the prediction model 110 corresponding to each group. Namely, the first compilation data 121 is input to the first prediction model 111, the second compilation data 122 is input to the second prediction model 112, the third compilation data 123 is input to the third prediction model 113, and the fourth compilation data 124 is input to the fourth prediction model 114. Warning information is then generated based on dangerous locations as predicted using each of the prediction models 110.

Note that the central server 30 re-compiles behavior information and updates the behavior information of the groups compiled using the initial behavior information. When this has been performed, as illustrated in FIG. 11B, the compiled data sets 120 are configured by updated first compilation data 121A, second compilation data 122A, third compilation data 123A, and fourth compilation data 124A. Moreover, updating the behavior information may cause the hourly traffic volume, this being the attribute, to change in the respective compiled data sets 120. In such cases, prediction processing is performed based on the new traffic volume.

For example, the updated first compilation data 121A is input to the third prediction model 113, and the updated second compilation data 122A is input to the first prediction model 111. The updated third compilation data 123A is input to the second prediction model 112, and the updated fourth compilation data 124A is input to the fourth prediction model 114. Warning information is then generated based on dangerous locations as predicted using each of the prediction models 110.

The danger prediction system 10 of the present exemplary embodiment exhibits the following advantageous effect in addition to the advantageous effects of the first exemplary embodiment. Namely, in the present exemplary embodiment a separate prediction model 110 is employed for each similar attribute when performing danger prediction enables danger prediction to be performed according to the characteristics of similar locations.

### Third Exemplary Embodiment

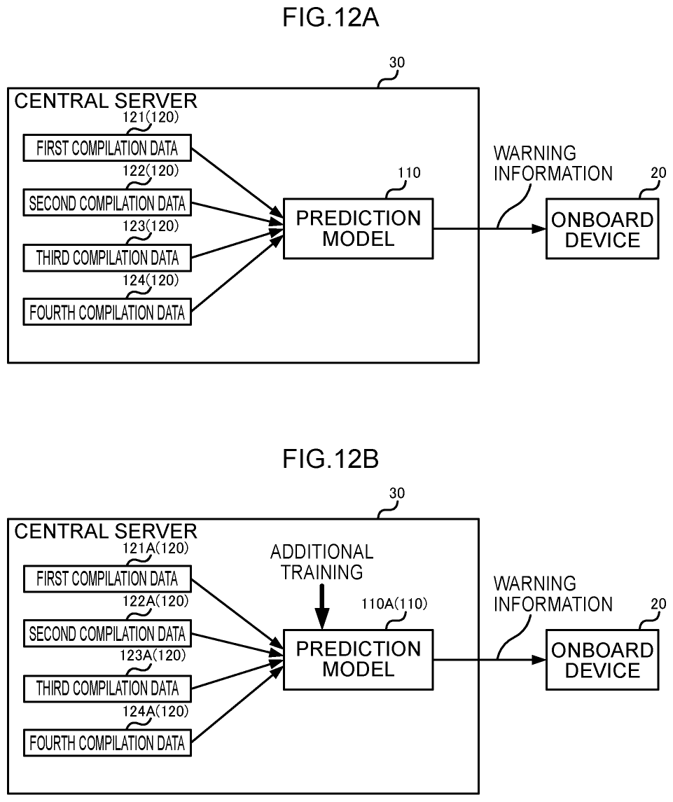

In the first exemplary embodiment, after the compiled data sets 120 have been updated, the acquired behavior information is input to the prediction model 110 as-is. By contrast, as illustrated in FIG. 12B, a third exemplary embodiment differs from the first exemplary embodiment in that the updated compiled data sets 120 are employed in both updating of the prediction model 110 and in prediction. In the following explanation, configurations matching those of the first exemplary embodiment are allocated the same reference numerals, and explanation thereof is omitted. Explanation follows regarding points that differ from the first exemplary embodiment.

First, the prediction section 280 of the present exemplary embodiment performs danger prediction by inputting the behavior information to the one prediction model 110. Namely, as illustrated in FIG. 12A, the first compilation data 121, the second compilation data 122, the third compilation data 123, and the fourth compilation data 124 are all input to the prediction model 110. Warning information is then generated based on the predicted dangerous locations.

Note that the central server 30 re-compiles behavior information and updates the behavior information of the groups compiled using the initial behavior information. When this has been performed, as illustrated in FIG. 12B, the compiled data sets 120 are configured by updated first compilation data 121A, second compilation data 122A, third compilation data 123A, and fourth compilation data 124A.

The training section 250 then performs additional training using the updated first compilation data 121A, second compilation data 122A, third compilation data 123A, and fourth compilation data 124A to generate an updated prediction model 110A. The prediction section 280 then inputs the updated first compilation data 121A, second compilation data 122A, third compilation data 123A, and fourth compilation data 124A to the updated prediction model 110A to perform danger prediction. Warning information is then generated based on dangerous locations as predicted by the prediction model 110A.

In the danger prediction system 10 of the present exemplary embodiment, the training section 250 performs additional training of the prediction model 110. The present exemplary embodiment exhibits the following advantageous effect in addition to the advantageous effects of the first exemplary embodiment. Namely, according to the present exemplary embodiment, employing the acquired behavior information to perform additional training of the prediction model 110 enables previously acquired behavior information to be reflected in danger prediction based on subsequently acquired behavior information. Moreover, the prediction model 110 of the present exemplary embodiment is compatible with online updates. There is therefore no need to re-generate the prediction model 110 using all data when updating the prediction model 110 by performing additional training.

### Fourth Exemplary Embodiment

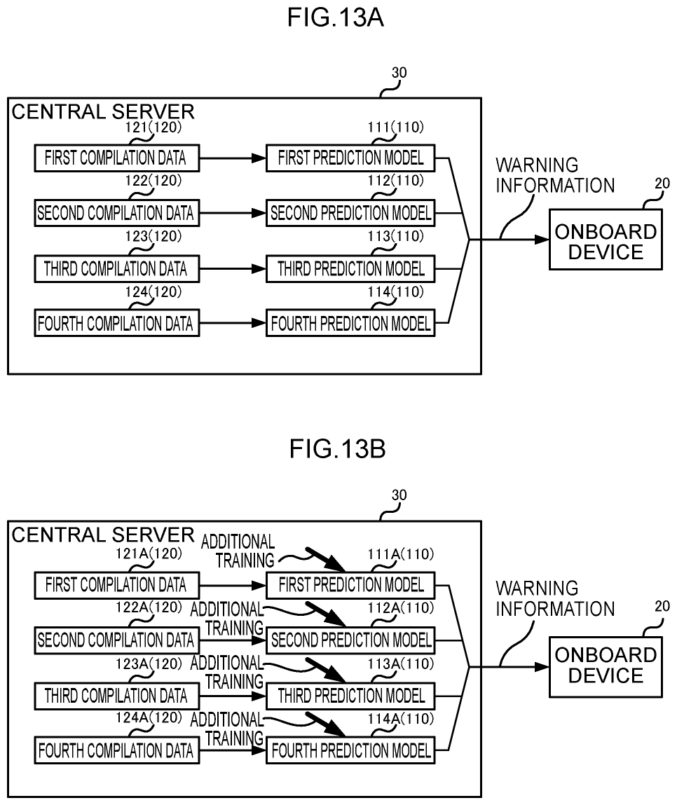

In the second exemplary embodiment, when the compiled data sets 120 have been updated, the acquired behavior information is input to the respective prediction models 110 as-is. By contrast, as illustrated in FIG. 13B, a fourth exemplary embodiment differs from the second exemplary embodiment in that updated compiled data sets 120 are employed in both updating of the prediction models 110 and in prediction. In the following explanation, configurations matching those of the first exemplary embodiment are allocated the same reference numerals, and explanation thereof is omitted. Explanation follows regarding points that differ from the first exemplary embodiment and the second exemplary embodiment.

The prediction models 110 of the present exemplary embodiment include a prediction model 110 for each attribute. Specifically, the prediction models 110 include the first prediction model 111 for the group G1, the second prediction model 112 for the group G2, the third prediction model 113 for the group G3, and the fourth prediction model 114 for the group G4.

As illustrated in FIG. 13A, the prediction section 280 of the present exemplary embodiment performs danger prediction by inputting behavior information to the prediction model 110 corresponding to each group. Namely, the first compilation data 121 is input to the first prediction model 111, the second compilation data 122 is input to the second prediction model 112, the third compilation data 123 is input to the third prediction model 113, and the fourth compilation data 124 is input to the fourth prediction model 114. Warning information is then generated based on dangerous locations as predicted by the respective prediction models 110.

Note that the central server 30 re-compiles behavior information and updates the behavior information of the groups compiled using the initial behavior information. When this has been performed, as illustrated in FIG. 13B, the compiled data sets 120 are configured by updated first compilation data 121A, second compilation data 122A, third compilation data 123A, and fourth compilation data 124A.

The training section 250 then performs additional training of the first prediction model 111 using the updated first compilation data 121A, and generates an updated first prediction model 111A. The training section 250 also performs additional training of the second prediction model 112 using the updated second compilation data 122A, and generates an updated second prediction model 112A. The training section 250 also performs additional training of the third prediction model 113 using the updated third compilation data 123A, and generates an updated third prediction model 113A. The training section 250 also performs additional training of the fourth prediction model 114 using the updated fourth compilation data 124A, and generates an updated fourth prediction model 114A.

The updated first compilation data 121 A is then input to the updated first prediction model 111A, and the updated second compilation data 122A is input to the updated second prediction model 112A. Moreover, the updated third compilation data 123A is input to the updated third prediction model 113A, and the updated fourth compilation data 124A is input to the updated fourth prediction model 114A. Warning information is then generated based on dangerous locations as predicted by the respective prediction models 110.

The danger prediction system 10 of the present exemplary embodiment exhibits the following advantageous effect in addition to the advantageous effects of the first exemplary embodiment and the second exemplary embodiment. Namely, the present exemplary embodiment reflects previously acquired behavior information when training the prediction model for each similar attribute, thereby enabling the precision of danger prediction for similar locations to be improved.

### Remarks

Although (A) the average hourly traffic volume is employed as the attribute in the respective exemplary embodiments described above, the attribute is not limited thereto. For example, (B) an average hourly incidence of dangerous driving, (C) a proportion of dangerous driving relative to the hourly traffic volume, (D) road width, (E) an average speed of passing vehicles, or (F) a combination of (A) to (E) may be employed as an attribute.

Although the compiling section 270 employs the graph configured by the nodes N and the edges E in addition to the attribute when performing compilation in the exemplary embodiments described above, there is no limitation thereto. As long as at least an attribute is employed in compilation, prediction precision can be improved even when danger prediction is performed for locations for which it has not been possible to secure sufficient data.

The various processing executed by the CPUs 20A, 30A reading software (a program) in the exemplary embodiments described above may be executed by various types of processor other than the CPUs. Such processors include programmable logic devices (PLDs) that allow circuit configuration to be modified post-manufacture, such as a field-programmable gate array (FPGA), and dedicated electric circuits, these being processors including a circuit configuration custom-designed to execute specific processing, such as an application specific integrated circuit (ASIC). The processing described above may be executed by any one of these various types of processor, or by a combination of two or more of the same type or different types of processor (such as plural FPGAs, or a combination of a CPU and an FPGA). The hardware structure of these various types of processors is more specifically an electric circuit combining circuit elements such as semiconductor elements.

The exemplary embodiments described above have described implementations in which the program is in a format pre-stored (installed) in a computer-readable non-transitory storage medium. For example, the processing program 100 of the central server 30 is pre-stored in the corresponding storage 30D. However, there is no limitation thereto, and the respective programs may be provided in a format recorded on a non-transitory storage medium such as compact disc read only memory (CD-ROM), digital versatile disc read only memory (DVD-ROM), or universal serial bus (USB) memory. Alternatively, the program may be provided in a format downloadable from an external device over a network.

Instead of being executed by a single processor, the processing of the exemplary embodiments described above may be executed by plural processors working collaboratively. The processing flows explained in the above exemplary embodiments are merely examples, and superfluous steps may be omitted, new steps may be added, or the processing sequences may be changed within a range not departing from the spirit thereof.

What is claimed is:

1. A danger prediction device, comprising a processor, the processor being configured to:
acquire, from a traveling vehicle, position information for the traveling vehicle on a travel path and behavior information for the traveling vehicle at a location corresponding to the position information;
compile, from a plurality of acquired items of behavior information, behavior information corresponding to position information for locations having a similar attribute; and
input compiled behavior information to a prediction model generated based on pre-gathered vehicle behavior information and a danger level corresponding to the pre-gathered vehicle behavior information, and perform danger prediction for a location corresponding to the compiled behavior information.

2. The danger prediction device of claim 1, wherein, in a case in which locations having a similar attribute are set as nodes and the travel path is set as an edge, the processor is further configured to compile behavior information corresponding to position information for the nodes that are linked by the edge.

3. The danger prediction device of claim 1, wherein the processor is further configured to:
acquire environmental information relating to an environment of the travel path; and
reflect the acquired environmental information in prediction.

4. The danger prediction device of claim 3, wherein, in a case in which a prohibition of the vehicle from traveling on the travel path is acquired as the environmental information, the processor is further configured to exclude, from the prediction, a location on the travel path at which travel of the vehicle is prohibited.

5. The danger prediction device of claim 3, wherein meteorological information is acquired as the environmental information, and in a case in which a weather event exceeding a preset level is occurring at a location on the travel path, the processor is further configured to add, to the prediction, the location at which the weather event exceeding the preset level is occurring.

6. The danger prediction device of claim 1, wherein the processor is further configured to perform additional training of the prediction model based on the acquired behavior information.

7. The danger prediction device of claim 1, wherein the prediction model is one of a plurality of prediction models, which respectively correspond to a plurality of similar attributes, and the processor is further configured to employ the plurality of prediction models to perform danger prediction for locations corresponding to each of the plurality of similar attributes.

8. The danger prediction device of claim 6, wherein the prediction model is one of a plurality of prediction models, which respectively correspond to a plurality of similar attributes, and the processor is further configured to employ the plurality of prediction models to perform danger prediction for locations corresponding to each of the plurality of similar attributes

9. The danger prediction device of claim 8, wherein the processor is further configured to perform additional training for each of the plurality of prediction models for corresponding locations based on behavior information for each of the plurality of similar attributes.

10. The danger prediction device of claim 1, wherein the processor is further configured to provide a vehicle with position information regarding a location that has been predicted to be dangerous.

11. The danger prediction device of claim 10, wherein the processor is further configured to provide a vehicle with warning information when the vehicle approaches a location that has been predicted to be dangerous.

12. A danger prediction system, comprising:
the danger prediction device of claim 1; and
a plurality of the traveling vehicles, each being communicatively connected to the danger prediction device.

13. A method of danger prediction processing for execution by a computer, the processing comprising:
acquisition processing of acquiring, from a traveling vehicle, position information for the traveling vehicle on a travel path and behavior information for the traveling vehicle at a location corresponding to the position information;
compilation processing of compiling, from a plurality of items of behavior information acquired by the acquisition processing, behavior information corresponding to position information for locations having a similar attribute; and
prediction processing of inputting behavior information compiled by the compilation processing to a prediction model generated based on pre-gathered vehicle behavior information and a danger level corresponding to the pre-gathered vehicle behavior information, and performing danger prediction for a location corresponding to the compiled behavior information.

14. A non-transitory storage medium storing a program executable by a computer to perform processing, the processing comprising:
acquisition processing of acquiring, from a traveling vehicle, position information for the traveling vehicle on a travel path and behavior information for the traveling vehicle at a location corresponding to the position information;
compilation processing of compiling, from a plurality of items of behavior information acquired by the acquisition processing, behavior information corresponding to position information for locations having a similar attribute; and
prediction processing of inputting behavior information compiled by the compilation processing to a prediction model generated based on pre-gathered vehicle behavior information and a danger level corresponding to the pre-gathered vehicle behavior information, and performing danger prediction for a location corresponding to the compiled behavior information.
